(19) United States
(12) Patent Application Publication
(10) Pub. No.: US 2025/0027533 A1
(43) Pub. Date: Jan. 23, 2025

(54) SLIDING SEGMENT WITH CROWNING

(71) Applicant: COB Bearings GmbH, Desselbrunn (AT)

(72) Inventors: Maximilian Prölss, BERLIN (DE); PETER DECKER, HANNOVER (DE)

(21) Appl. No.: 18/774,156

(22) Filed: Jul. 16, 2024

(30) Foreign Application Priority Data
Jul. 18, 2023 (DE) 102023118943.3

(51) Int. Cl. F16C 17/02; F16C 33/10

(52) U.S. Cl. CPC F16C 17/02; F16C 33/103; F16C 2360/31

(57) ABSTRACT

The present invention relates to an improved sliding segment having a crowning on the sliding surface and a corresponding radial sliding bearing and their applications in main rotor bearings and wind turbines.

### BRIEF DESCRIPTION OF THE INVENTION

The present invention relates to an improved sliding segment with a sliding surface having a crowning and a corresponding radial sliding bearing and their applications in main rotor bearings and wind turbines.

Main rotor bearings in wind turbines are increasingly being designed as plain bearings. What most of the known designs have in common is that they are segmented radial bearings.

In WO 2011/003482 A2, for example, such a segmented radial plain bearing is disclosed as the main bearing of a wind turbine. The advantage of this type of bearing is that it can be exchanged segment by segment.

EP 3 464 896 B1 describes a combined radial-axial bearing as the main bearing of a wind turbine, in which the rotor hub and the generator rotor have a common main bearing, which is divided into two bearing sections spaced apart from one another in axial direction. The first bearing section being a first radial plain bearing and has a first axial plain bearing, and the second bearing section has a second radial plain bearing and a second axial plain bearing.

In the course of the further development of the rotor main shafts with sliding bearings, it was determined that the radial and axial tilting of the sliding segments relative to the shaft and housing must be ensured, otherwise edge loading and premature bearing wear may occur.

One possibility of segment support for the bearing housing is described in EP 3577356 B1. Here, the bearing segment is supported against the bearing housing via a ball joint with a support structure (ball-and-socket construction) in order to be able to adapt to the deformations of the main shaft and bearing housing.

The DE 102019131245 A1 describes a bearing arrangement for supporting a rotor shaft of a wind turbine, the bearing arrangement having an outer housing and a bearing with a plurality of plain bearing segments, the bearing having two annular support bodies, each with a spherical mating surface, which are arranged on the outer housing and the plain bearing segments rest on the counter surfaces with a spherical contact surface. Consequently, the entire bearing unit can elastically move in the bearing body in order to compensate for deformation of the rotor shaft. A similar design principle is also described in U.S. Pat. No. 8,075,190 B1.

What all known constructions have in common is that they are designed to compensating for the global deformations of the bearing, the shaft and the bearing environment.

However, between the sliding surface of the shaft and the bearing segments, the hydrodynamic pressure also causes a deformation in the contact surface of the shaft and the sliding surface of the segment. Such an effect cannot be compensated by the known constructions.

The object of the present invention is therefore to provide a sliding bearing, in which a deformation between the sliding surface of the shaft and the bearing segments due to the hydrodynamic pressure is reduced, compensated for or prevented.

The present invention therefore relates to a sliding segment which can be connected to a bearing housing, the sliding segment having a sliding layer on the side facing the shaft which forms a sliding surface which interacts with the sliding surface of the shaft, the sliding layer further having a crowning in the direction of the shaft axis. The crowning is preferably a uniaxially convexly curved surface in the direction of the shaft. In one embodiment, the crowning is only a few micrometres (μm) high to a few 1/100 mm high. In a preferred embodiment, the crowning of the sliding layer has a height in the range of 5 μm to 200 μm.

In one aspect of the invention, the sliding surface of the sliding segment has a segment diameter predetermined by the shaft diameter in the direction of rotation of the shaft.

The sliding layer of the sliding segment preferably has a fibre-reinforced polymer as the sliding material. It particularly preferably comprises a fibre-reinforced polyether-ether-ketone as a sliding material.

In one embodiment, the spring element of the sliding segment is held by a guide element that encloses the spring element, the guide element being attached to the sliding segment and the support structure. In a preferred aspect, a gap is arranged between the spring element and the guide element.

The present invention further relates to a radial plain bearing which has a plurality of previously described sliding segments within a bearing housing, each sliding segment being connected to the bearing housing on one side via a support structure and being in contact with the shaft on the opposite side through its sliding surface. The plain bearing segments are preferably arranged in a circle around the shaft. The number of them surrounding the shaft is preferably dependent on their own size, as well as the size of the shaft and/or its diameter. In one aspect of the invention, the plain bearing segments are arranged symmetrically around the shaft.

The sliding segments are preferably arranged relative to the shaft in such a way that a space is formed between the sliding surface of the at least one sliding segment and the sliding surface of the shaft, which keeps the sliding surfaces at a distance from one another. In one aspect of the invention, the space between the shaft and the sliding segment is filled with a lubricating liquid, preferably oil, grease and/or a fluid.

In addition, the invention also relates to the use of the previously described sliding segments with crowning and radial sliding bearings in main rotor bearings and wind turbines.

The present invention is characterized by the embodiments in the claims and described in more detail by the statements in the following description, the examples and the drawings.

### DESCRIPTION OF THE DRAWINGS

FIG. 1 Schematic drawing of a main rotor shaft with several plain bearings.

FIG. 2 Schematic drawing of a sliding segment with a support structure, with the direction of the shaft axis (arrow) marked (side view).

FIG. 3 Schematic drawing of the deformation of the sliding surface of the sliding segment and the shaft during hydrodynamic pressure build-up (side view).

FIG. 4 Schematic view of a sliding segment according to the invention with a sliding layer having a crowning.

FIG. 5 Perspective schematic view of a sliding segment according to the invention with a sliding layer having a crowning.

FIG. 6 Schematic view of the effect of a sliding segment according to the invention on the pressure distribution.

### DETAILED DESCRIPTION OF THE INVENTION

The present invention relates to an improved sliding segment (1) with a sliding surface having a crowning in axial direction (2) and a corresponding radial sliding bearing and their applications in main rotor bearings and wind turbines.

Hereinafter, the articles “a” and all derivatives thereof, as used herein, should generally be understood as “a/it or more” unless otherwise specified or apparent from the context as a singular form.

The term “shaft” describes an elongated cylindrical machine element that is designed to be movable to transmit rotary movements and torques. In a preferred embodiment, it is at least a steel shaft of a gearbox of a wind turbine or a wind turbine main shaft. The wind turbines are preferably onshore or offshore systems. Although the present invention is described below in relation to the main drive shafts of wind turbines, it is in principle also possible for the plain bearing to also be used in other applications. These include, but are not limited to the following list, hydraulic pistons, quill guides, support bearings, worm racks, screws, guide rails, bearing rings and other components. Accordingly, the terms “shaft” and “main shaft” will be used interchangeably without limiting the invention in any way, and refer to the rotating part supported by the main bearing. As a rule, these are “hydrodynamic bearings” or “fluid bearings” in which the bearing carries the load on a thin lubricating fluid.

Plain bearings are commonly used in larger machines. The present invention relates in particular to a radial plain bearing which has a plurality of sliding segments (1) within a bearing housing (12). Each sliding segment (1) is connected to the bearing housing (12) on one side via a support structure (5). On the other hand, the sliding segment (1) has a sliding surface (2) which is in contact with the shaft (10). Each sliding segment (1) is preferably movably and flexibly attached to the support structure (5), which means that they are also somewhat adaptable to tolerances and/or deformations due to operational changes in the sliding bearing compared to the bearing housing.

A preferred embodiment of the sliding bearing comprises several guide segments (1) which are arranged distributed around the circumference of a shaft (10). Each sliding segment (1) is arranged in such a way that its sliding surface (2) rests on the shaft (10). In one aspect of the invention, a spring element (13) is attached to the back of each sliding segment (1) between the sliding segment (1) and a support structure (5), which is held by a guide element that encloses the spring element (13). wherein the guide element is attached to the sliding segment (1) and the support structure (5). The sliding bearing is preferably designed in such a way that a gap is arranged between the spring element (13) and the guide element, which allows mobility between the spring element (13) and the guide element.

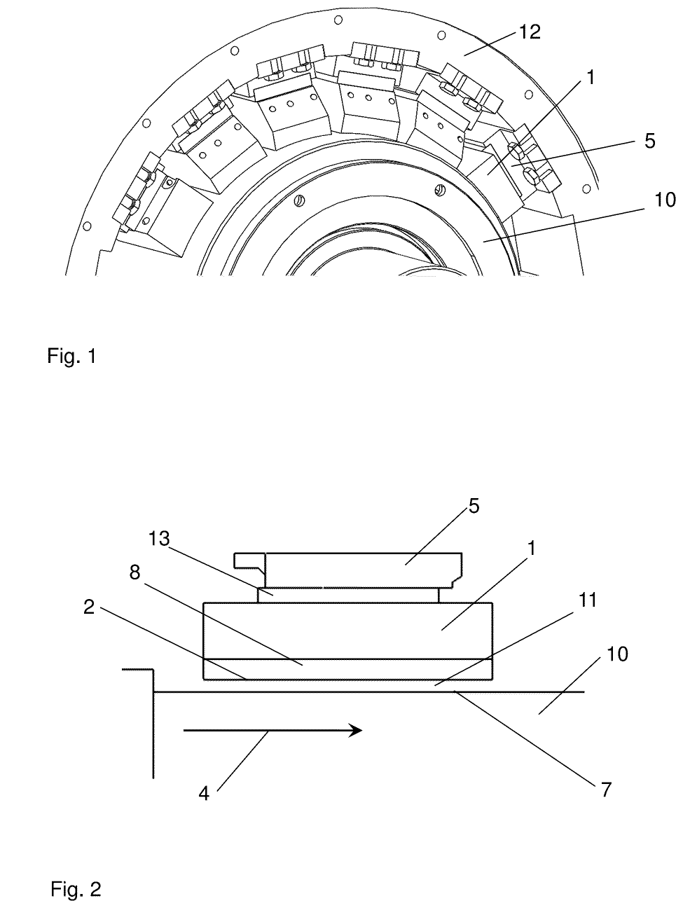

Such a preferred arrangement of the sliding segments (1) in the bearing housing (12) can be seen in FIG. 1. Each sliding segment (1) is supported on the support structure (5) via a tilting spring element (13) and is connected to the bearing housing (12) via the support structure (5). In such an embodiment, the shaft (10) slides with its surface on the sliding segments (1), the sliding surface of the shaft (7) interacting with a sliding surface (2) of the sliding segments (1). The bearing arrangement shown in FIG. 1 preferably forms a radial bearing in which the plain bearing has a plurality of plain bearing segments (1) which are arranged in a circle around the shaft (10). The number of rotating plain bearing segments (1) which surround the shaft (10) can depend on their own size, their diameter and the size of the shaft (10) and/or its diameter. Preferably, the sliding bearing segments (1) surround the shaft (10) almost completely, so that the shaft (10) can slide completely on the sliding segments (1), with the exception of smaller intermediate areas that arise between the individual sliding segments (1). The size of the plain bearing segments (1) is usually constant, so that a symmetrical arrangement of plain bearing segments (1) is formed. However, in some applications it can also be provided that the plain bearing segments (1) that revolve around the shaft (10) also have different sizes. The design and arrangement of the plain bearing segments (1) is particularly aimed at ensuring that their sliding surface (2) adapts to the surface of the counterpart to be supported. In order to enable the shaft (10) to be reliably received by the plain bearing segments (1), these preferably have a full-surface sliding surface (2) that points in the direction of the shaft.

FIG. 2 shows a preferred embodiment of a sliding segment (1) with a support structure (5), which absorbs this hydrodynamic pressure between the components, i.e. preferably distributes the pressure evenly. FIG. 2 shows the sliding segment (1) with the support structure (5) (without bearing housing) as well as the sketched shaft (10) and its sliding surface (17). The sliding surface (2) of the sliding segment (1) interacts with the sliding surface (7) of the shaft (10). As can be seen from FIG. 2, the sliding segment (1) has a special sliding layer (8) on its side facing the shaft (10). This sliding layer (8) comprises a sliding material, which is preferably a fibre-reinforced plastic. In a particularly preferred aspect of the invention, the sliding layer (8) is a fibre-reinforced polyether-ether-ketone. The side of this sliding layer (8) facing the shaft (10) forms the sliding surface (2), which interacts with the sliding surface of the shaft (7). The direction of the shaft axis (4) is illustrated by the arrow. The two sliding surfaces are not in direct contact with each other, but are spaced apart by a gap (11) due to the hydrodynamic pressure build-up that occurs when the shaft rotates. The space (11) between the shaft (10) and the sliding segment (1) is usually filled with a lubricating liquid, such as oil, grease and/or another fluid. The intermediate space (11) can be supplied with a lubricant, for example by means of an external reservoir, whereby the fluid can be introduced by means of a pump (not shown). In order to achieve lubrication, one or more cavities, depressions and/or recesses, such as pockets, can be present, for example on or between the sliding segments (1). The gap (11) filled with a lubricant consequently separates the sliding surfaces (2) of the sliding segments (1) from the sliding surface of the shaft (7).

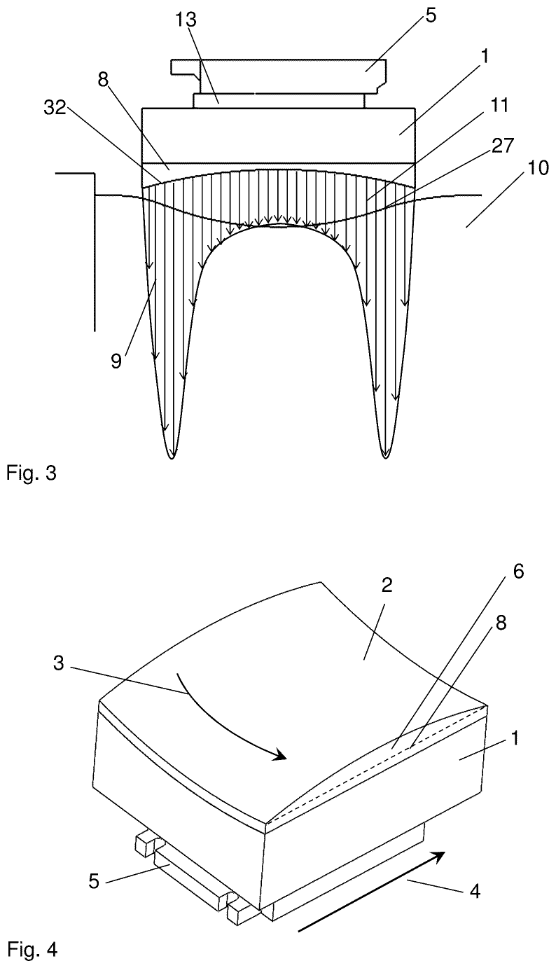

As already described above, due to the hydrodynamic pressure, in addition to the global deformations of the bearing, the shaft (10) and/or the bearing environment, deformations occur between the sliding surface (2) of the shaft (10) and the plain bearing segments (1). These are shown schematically in FIG. 3. Here the hydrodynamic pressure build-up (9) and the elastic deformation (32) of the sliding surface (2) of the sliding segment (1) and the deformation (27) of the sliding surface (27) of the shaft (10) are shown, whereby the elastic deformation (32) the hydrodynamic pressure (9) at the bearing edges becomes very high and the lubrication gap width (11) at the bearing edges becomes very small. Mixed friction and wear cannot be ruled out.

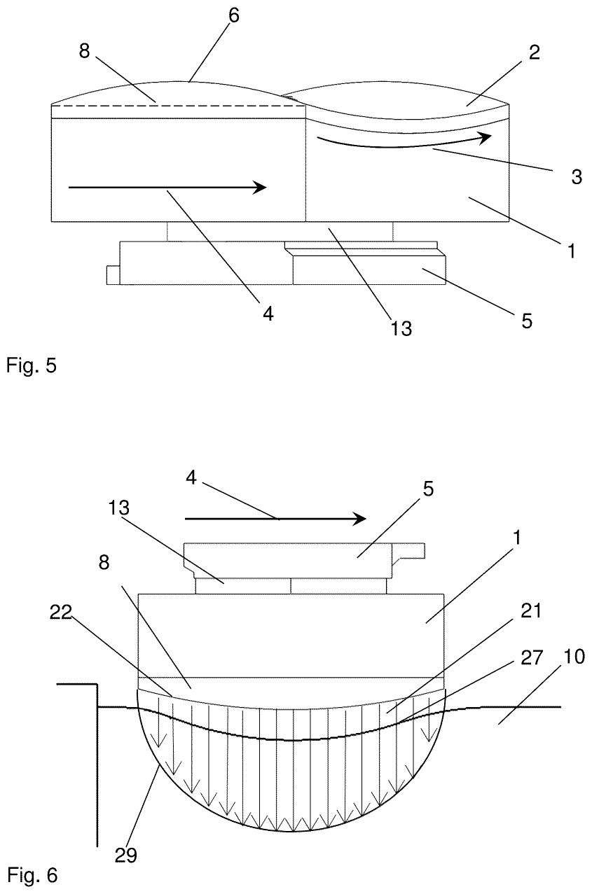

In order to counteract the deformations between the sliding surface (2) of the shaft (10) and the plain bearing segments (1), i.e. to reduce or prevent them, a plain bearing segment (1) was developed, which is shown in FIG. 4 and FIG. 5. The radial tilting segment modified according to the invention is shown in different views. As shown in the previous figures, the sliding segment (1) is connected to the bearing housing (12) via its support structure (5) (not shown). However, unlike the usual sliding segments, the sliding surface (2) of the sliding segment (1) has a crowning (6). The term “crowning” describes the shape and quality of the surface of the sliding surface (2), in particular the change in the diameter of the sliding layer (8) in the axial direction (4). In the direction of rotation (3) of the shaft (10), the sliding segment (1) has the segment diameter specified by the shaft diameter. In the direction of the axis (4), however, the sliding segment (1) has a crowning (6) of the sliding layer (8). The crowning (6) can have different shapes, for example, but not exclusively, the crowning can preferably be a uniaxially convex curved surface (plano-convex) in relation to the usual planar surface of the sliding layer (8), as shown in particular in FIG. 5 can be seen. The crowning (6) is shown here greatly exaggerated for clarity. In reality, the crowning (6) is only a few micrometres (μm) up to a few 1/100 mm. In a particularly preferred aspect of the invention, the crowning (6) of the sliding layer (8) of the sliding segment (1) is in the range from 5 μm to 200 μm.

Investigations showed that such a crowning (6) of the sliding layer (8) leads to a more balanced pressure curve (29), as shown schematically in FIG. 6. Due to the crowned sliding layer (8) of the sliding segment (1) according to the invention, the gap width (21) no longer has any minimums on the bearing edges, since the pressure curve (29) is much more uniform than before. Furthermore, it can be seen in FIG. 6 that the crowned shape of the sliding surface (22) absorbs the deformation of the running surface of the shaft (27) and thus evens out the course of the gap width (21) over the bearing width (4), i.e. makes it more regular.

Based on the above findings regarding the compensation of the deformation between the sliding surface (7) of the shaft and the at least one sliding segment (1) due to the hydrodynamic pressure, the present invention relates, in addition to the improved sliding segments (1) and the associated sliding bearings, to a main rotor bearing, preferably within a wind turbine, as well as the wind turbine itself.

The main rotor bearing, which is preferably arranged within a wind turbine, has a radial sliding bearing, which preferably has a plurality of sliding segments (1), which are arranged on a support structure (5) and, in a preferred aspect of the invention, have a tilting spring element (13), which is connected with the support structure. The sliding segments (1) are connected to the bearing housing (12) by the support structure (5). The sliding segments (1) have a sliding surface (2) on the side facing the shaft (10), which comprises a sliding layer (8) made of a sliding material, preferably a fibre-reinforced poly-ether-ether-ketone. A gap (11) is formed between the sliding surfaces (2, 7) of the shaft (10) and the sliding segment (1), which can be filled with a fluid, such as oil. Furthermore, the sliding segment (1) has a crowning (6) of the sliding layer (8) in the direction of the axis (4), which is in particular a convexly curved profiling (6) which increases the diameter of the sliding surface (2) by only a few micrometres (μm) up to a few 1/100 mm, particularly preferably from 5 μm to 200 μm. The crowning is also preferably made of sliding material, preferably a fibre-reinforced poly-ether-ether-ketone.

The wind turbine according to the invention with at least one previously described plain bearing and/or a main rotor bearing usually has a rotor that is mounted on a tower and can have a different number and shape of rotor blades. The rotor's job is to convert the kinetic energy of the wind into rotational energy. The wind turbine therefore comprises, in one aspect, a rotor, a tower and a gearbox, wherein the rotor is connected to the gearbox in a torque-transmitting manner via a shaft, which has at least one previously described sliding bearing with a plurality of radially arranged sliding segments, as described above, or a previously described main rotor bearing. The transmission is in turn connected to a power generator. The power generator can be any technical device that converts mechanical, chemical, thermal or electromagnetic energy directly into electrical energy and vice versa. Since the present invention is preferably designed for use within wind turbines, the power generator in this case preferably refers to a generator in which energy is transferred from kinetic energy to electrical energy. Although the invention has been described in relation to wind turbines, its application is not intended to be limited to such. The crowned guide segments, plain bearings and main rotor bearings shown here can also be used in other industrial applications.

These and other embodiments of the present invention are disclosed in and are encompassed by the specification and examples. Further literature on known materials, methods and applications that can be used in accordance with the present invention can be accessed from public libraries and databases, for example using electronic devices. A more complete understanding of the invention may be obtained by reference to the figures, which are provided for purposes of illustration and are not intended to limit the scope of the invention.

### BEZUGSZEICHENLISTE

1. Segment
2. Sliding Surface
3. Direction of Rotation
4. Direction of the Axis
5. Support Structure
6. Crowning
7. Sliding Surface of the Shaft
8. Sliding Layer
9. Pressure Distribution of a Segment without Crowning
10. Shaft
11. Gap and Hydrodynamic Pressure
12. Bearing Housing
13. Spring Element
21. Gap of a Segment with Crowning
22. Sliding Surface with Crowning
27. Deformation of Saft
14. Pressure Distribution of a Segment with Crowning
32. Deformation of the Sliding Surface without Crowning

1. Sliding segment, which can be connected to a bearing housin, the sliding segmenthaving a sliding layer n the side facing the shaft which forms a sliding surface which is connected to the Sliding surface of the shaft interacts, the sliding layer also having a crowning in the direction of the axis.

2. Sliding segmentaccording to claim 1, wherein the sliding surface of the sliding segmentin the direction of rotationof the shaft has a segment diameter predetermined by the shaft diameter.

3. Sliding segmentaccording to claim 1, wherein the crowning is a uniaxially convex curved surface in the direction of the shaft.

4. Sliding segmentaccording to claim 1, wherein the crowning is only a few micrometres (μm) up to a few 1/100 mm high.

5. Sliding segmentaccording to claim 1, wherein the crowning of the sliding layer of the sliding segment (to form the sliding layer has a height in the range of 5 μm to 200 μm.

6. Sliding segmentaccording to claim 1, wherein the sliding layer has a fibre-reinforced plastic as the sliding material, preferably wherein the sliding layer comprises a fibre-reinforced poly-ether-ether-ketone as the sliding material.

7. Sliding segmentaccording to claim 1, wherein a spring element is attached between the sliding segment and a support structure, which is held by a guide element which encloses the spring element, wherein the guide element is attached to the sliding segment and the support structure and a gap is preferably arranged between the spring element and the guide element.

8. Radial plain bearing, which has a plurality of sliding segmentsaccording to claim 1 within a bearing housing, each sliding segmentbeing connected to the bearing housing on one side via a support structure and on the opposite side is in contact with the shaft through its crowned sliding surface, preferably with several sliding bearing segmentsbeing arranged in a circle around the shaft and the number of sliding segments around the shaft, depending on its own size, its diameter and the size of the shaft and/or its diameter, preferably wherein the sliding segments are arranged symmetrically around the shaft.

9. Radial plain bearing according to claim 8, wherein the sliding surface of at least one sliding segmentand the sliding surface of the shaft are spaced apart from one another by a gap and preferably the gap filled with a lubricating liquid, preferably oil, grease and/or a fluid, is filled.

10. Main rotor bearing comprising at least one sliding segment according to claim 1.

11. Wind turbine comprising at least one sliding segment according to claim 1, including at least one radial plain bearing and a main rotor bearing.
